(19) United States
(12) Patent Application Publication
(10) Pub. No.: US 2026/0063570 A1
(43) Pub. Date: Mar. 5, 2026

(54) WAFER INSPECTION METHOD AND METHOD OF MANUFACTURING SEMICONDUCTOR DEVICE USING THE SAME

(71) Applicant: Samsung Electronics Co., Ltd., Suwon-si (KR)

(72) Inventors: Hyunsoo Kwak, Suwon-si (KR); Sungyoon Ryu, Suwon-si (KR); Hyeungcheol Mun, Suwon-si (KR); Kwangseok Kim, Suwon-si (KR); Minjin Kim, Suwon-si (KR); Younghoon Sohn, Suwon-si (KR)

(21) Appl. No.: 19/277,503

(22) Filed: Jul. 23, 2025

(30) Foreign Application Priority Data
Sep. 2, 2024 (KR) 10-2024-0118808
Dec. 19, 2024 (KR) 10-2024-0191703

(51) Int. Cl. G01N 21/95; G01N 21/956

(52) U.S. Cl. CPC G01N 21/9501; G01N 21/956

(57) ABSTRACT

Provided is a wafer inspection method including obtaining spectrum data for a wafer, sampling the spectrum data to obtain a first measurement position on the wafer, measuring a characteristic value of the wafer at the first measurement position, and generating a prediction model, using the spectrum data and the characteristic value at the first measurement position.

### CROSS REFERENCE TO RELATED APPLICATIONS

This application is based on and claims priority under 35 U.S.C. § 119 to Korean Patent Application Nos. 10-2024-0118808, filed on Sep. 2, 2024, and 10-2024-0191703, filed on Dec. 19, 2024, in the Korean Intellectual Property Office, the disclosures of which are incorporated by reference herein in their entirety.

### BACKGROUND

The inventive concept relates to a wafer inspection method and a method of manufacturing a semiconductor device.

Semiconductor devices have been developed in the trend of reducing channel length or increasing the number of layers to increase energy efficiency and increase storage capacity per unit area. For this purpose, cutting-edge equipment is used in manufacturing semiconductor devices, and as the difficulty of semiconductor device manufacturing technology increases, the demand for fast and precise measurement technology is also increasing.

### SUMMARY

Aspects of the inventive concept provide a wafer inspection method capable of accurately confirming the characteristics of a wafer at a high speed and a method of manufacturing a semiconductor device including the same.

In addition, issues addressed by the technical spirit of the present inventive concept are not limited to the issues mentioned above, and other issues not mentioned above and other aspects of the inventive concept will be clearly understood by those skilled in the art from the following description.

According to an aspect of the inventive concept, there is provided a wafer inspection method including obtaining spectrum data for a wafer, obtaining a first measurement position on the wafer by sampling the spectrum data, measuring a characteristic value of the wafer at the first measurement position, and generating a prediction model using the spectrum data and the characteristic value at the first measurement position.

According to an aspect of the inventive concept, there is provided a wafer inspection method including obtaining spectrum data for a wafer, classifying the spectrum data into k groups (k is a natural number greater than or equal to 2), selecting a total of n (n is a natural number greater than or equal to k) spectrum data from the k groups, measuring characteristic values of the wafer at first measurement positions corresponding to the n spectrum data respectively, generating a prediction model using the n spectrum data and the characteristic values, and outputting a predicted characteristic value of the wafer by inputting spectrum data for the wafer into the prediction model.

According to an aspect of the inventive concept, there is provided a method of manufacturing a semiconductor device, the method including performing a semiconductor process on a wafer, obtaining spectrum data for all chips included in the wafer, selecting sample spectrum data by sampling the spectrum data based on a k-means clustering algorithm, measuring characteristic values of the wafer at first measurement positions on the wafer corresponding to the sample spectrum data, generating a prediction model for performing regression analysis based on the sample spectrum data and the characteristic values, and outputting a predicted characteristic value of the wafer by inputting spectrum data for the wafer into the prediction model.

### BRIEF DESCRIPTION OF THE DRAWINGS

Embodiments will be more clearly understood from the following detailed description taken in conjunction with the accompanying drawings in which:

FIG. 1 is a flowchart for explaining a wafer inspection method according to an embodiment;

FIG. 2 is a schematic diagram for explaining spectral ellipsometry according to an embodiment;

FIG. 3 is a diagram for explaining a plan view layout of a wafer according to an embodiment;

FIG. 4 is a flowchart for explaining a wafer inspection method according to an embodiment;

FIG. 5 is a diagram for explaining a wafer inspection method according to an embodiment;

FIG. 6 is a diagram illustrating spectrum data according to an embodiment;

FIG. 7 is a diagram for explaining k-means clustering according to an embodiment;

FIG. 8 is a diagram for explaining a wafer inspection method according to an embodiment;

FIG. 9 is a graph showing evaluation data of a wafer inspection method according to an embodiment;

FIG. 10 is a graph showing evaluation data of a wafer inspection method according to an embodiment; and

FIG. 11 is a flowchart explaining a method of manufacturing a semiconductor device according to an embodiment.

### DETAILED DESCRIPTION OF THE EMBODIMENTS

Hereafter, the embodiments of the inventive concept will be fully described with reference to the accompanying drawings. In the drawings, like reference numerals are used to indicate like elements and the descriptions thereof will not be repeated.

It will be understood that, although the terms “first”, “second”, etc., may be used herein to describe various elements, these elements should not be limited by these terms, but are only used to distinguish one element from another. As used herein, the singular forms are intended to include the plural forms as well, unless the context clearly indicates otherwise.

As used herein, a semiconductor device may refer, for example, to a device such as a semiconductor chip (e.g., memory chip and/or logic chip formed on a die), a stack of semiconductor chips, a semiconductor package including one or more semiconductor chips stacked on a package substrate, or a package-on-package device including a plurality of packages. These devices may be formed using ball grid arrays, wire bonding, through substrate vias, or other electrical connection elements, and may include memory devices such as volatile or non-volatile memory devices. Semiconductor packages may include a package substrate, one or more semiconductor chips, and an encapsulant formed on the package substrate and covering the semiconductor chips.

An electronic device, as used herein, may refer to these semiconductor devices, but may additionally include products that include these devices, such as a memory module, memory card, hard drive including additional components, or a mobile phone, laptop, tablet, desktop, camera, or other consumer electronic device, etc.

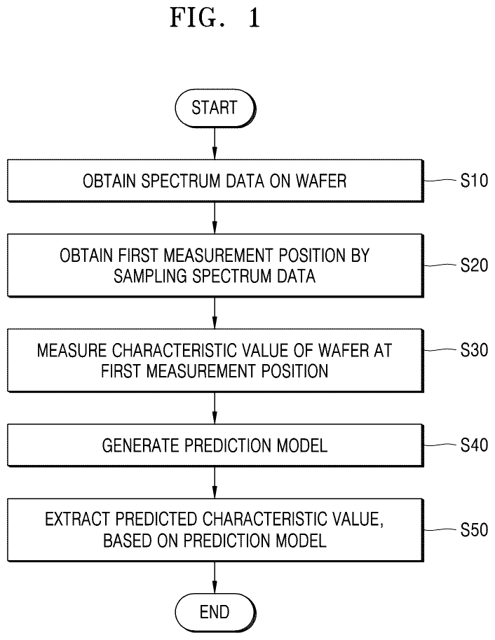

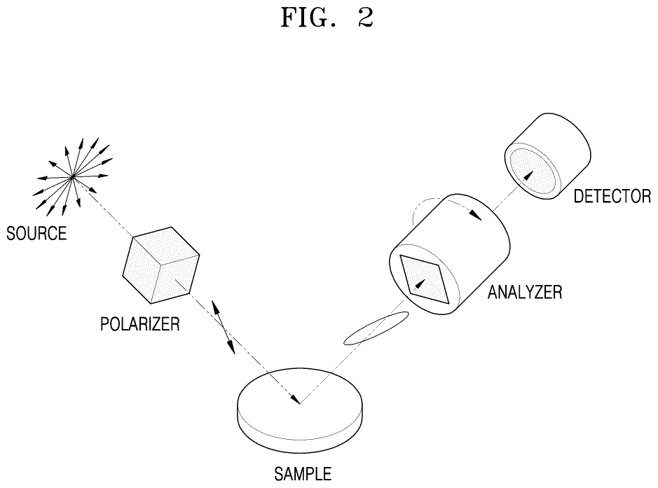

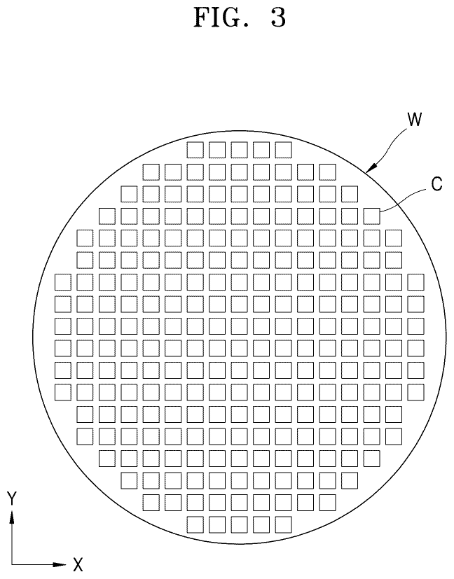

FIG. 1 is a flowchart illustrating a method of wafer inspection according to an embodiment. FIG. 2 is a schematic diagram illustrating spectral ellipsometry (SE) according to an embodiment. FIG. 3 is a diagram illustrating a plan view layout of a wafer according to an embodiment.

Referring to FIG. 1, a wafer inspection method according to an embodiment may include an operation of obtaining spectrum data for a wafer (S10), an operation of obtaining a first measurement position on the wafer by sampling spectrum data (S20), an operation of measuring characteristic values of the wafer at the first measurement position (S30), an operation of generating a prediction model (S40), and an operation of extracting predicted characteristic values based on or using the prediction model (S50).

First, spectrum data for the wafer may be obtained through a spectrum measuring device (S10). The spectrum measuring device may obtain reflectivity or transmittance of a measurement target (e.g., wafer) using a light source of a wide wavelength band. The spectrum data may be obtained through spectral microscopic inspection (SMI) having a relatively fast measurement speed. In one embodiment, the spectrum data for the wafer may be obtained using a spectrum measuring instrument that applies spectral ellipsometry, spectrophotometry, infrared spectroscopy, etc. In one embodiment, the spectrum data for the wafer may be obtained by measuring the reflectivity of the wafer using a visible light source in a range of about 370 nm to about 780 nm.

Referring to FIG. 2, the spectral ellipsometry is an optical technique for investigating structural characteristics such as the thickness of a thin film and a line width of a pattern formed on the thin film and dielectric characteristics such as the complex refractive index and dielectric function. The composition, roughness, thickness, depth, crystal characteristics, doping concentration, electrical conductivity, etc. of thin films included in an inspection target sample may be characterized by spectral ellipsometry.

The spectral ellipsometry is a technique for determining the characteristics of a thin film by comparing the change in polarization before and after interaction with a thin film, such as reflection and transmission, with a model. Here, the change in polarization may be expressed by an amplitude ratio Ψ′ and a phase difference Δ. The amplitude ratio refers to a ratio of the change in amplitude of a p wave and an s wave when light is reflected from the thin film. The phase difference refers to the difference in the phase change of the p wave and s wave when light is reflected from the thin film. Because the change in polarization depends on the type and thickness of the thin film constituent material, the thickness and optical constants of all types of films may be measured by using a non-contact method. According to the spectral ellipsometry, single or multiple layers with a thickness ranging from a single atomic layer or several angstroms to several micrometers may be characterized with high precision.

Referring to FIG. 2, unpolarized electromagnetic radiation emitted by a light source may be linearly polarized through a polarizer, and polarized electromagnetic waves of the radiation may be incident on a sample. Optionally, a compensator such as a retarder or a quarter wave plate may be further arranged in the optical path between the polarizer and the sample.

The polarized electromagnetic waves of the radiation may be reflected by the sample. The radiation reflected by the sample may reach the detector after passing through a second polarizer, commonly called an analyzer. Similarly to the compensator above, a second compensator may be arranged in the optical path between the analyzer and the sample.

The spectral ellipsometry is a specular optical inspection method in which angle of incidence and angle of reflection of beams are the same, such that the incident and reflected beams are on the plane of incidence. A polarization parallel to the plane of incidence is referred to as p-polarized, and a polarization perpendicular to the p-polarized and to the plane of incidence is referred to as s-polarized.

The spectral ellipsometry measures the complex reflectivity p, which may be parameterized by a reflection amplitude ratio Ψ′ and a phase difference Δ. The polarization state of light incident on a sample may be decomposed into s and p components. The amplitudes of the s and p components after reflection, normalized to the initial value, are denoted as rs and rp, respectively, below. At this time, rs, rp, and the complex reflectivity p satisfy Equation 1 below.

$$ρ = \frac{rp}{rs} = tan Ψ \cdot {e}^{i Δ} \qquad [ Equation 1 ]$$

By selecting the incident angle of light close to the Brewster angle of the sample, the difference between rp and rs may be maximized. Because spectral ellipsometry measures a ratio (or difference) of the two values, it may provide rigorous and highly reproducible measurement results. Accordingly, the spectral ellipsometry has the advantage of being relatively insensitive to light scattering and variations in inspection conditions and does not require a separate standard sample or reference light.

Except for exceptionally simple cases such as infinite thickness films or homogeneous films, the measured reflection amplitude ratio Ψ′ and phase difference Δ may not be directly converted to optical constants of a sample. Therefore, model analysis may generally be performed to obtain optical constants from the results of spectral ellipsometry. The Forouhi Bloomer model may be an example of the model. The model may be based on physical energy transfer or on free parameters for data fitting. The model may include the stacking order of layers included in the sample, optical constants (e.g., refractive index or dielectric function tensor) of each individual layer, and the thickness parameter.

The spectral ellipsometry may calculate the reflection amplitude ratio Ψ′ and the phase difference Δ using iterations (e.g., the least squares method) that change the optical constants and/or the thickness parameters. The Fresnel equation may be used to calculate the reflection amplitude ratio Ψ′ and the phase difference Δ. When the calculated reflection amplitude ratio Ψ and the phase difference Δ values match the experimental data, the corresponding optical constants and thickness values of the thin films may be determined as the optical constants and thicknesses of the thin films included in the sample.

Referring to FIG. 3, the wafer W to be inspected may include a plurality of semiconductor chips C (e.g., chip regions in the wafer W) which may be separated from each other in a later step of process to form a plurality of individual chips C. The wafer inspection method according to various embodiments may obtain spectrum data that measures all semiconductor chips C (or dies) included in the wafer W. For example, the spectrum data may also include information on the semiconductor chips C in the part where the process abnormality occurred in the wafer W. In one embodiment, when the wafer W includes m (m is a natural number greater than or equal to 2) semiconductor chips C (or dies), the spectrum data may be data for m spectra.

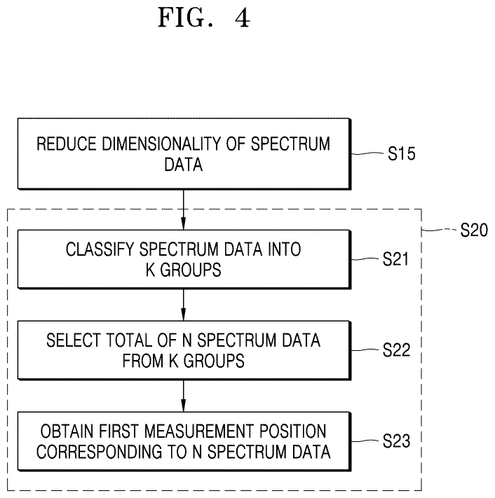

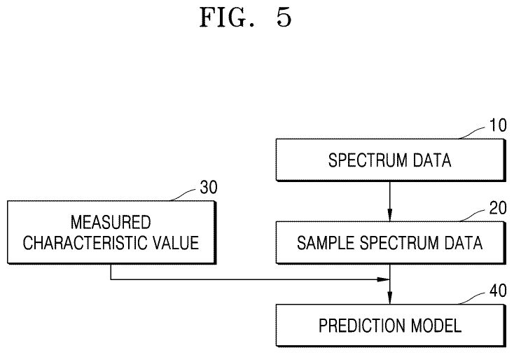

FIG. 4 is a flowchart explaining a wafer inspection method according to one embodiment. FIG. 5 is a diagram explaining a wafer inspection method according to one embodiment.

Referring to FIG. 4 and FIG. 5 together with FIG. 1, the wafer inspection method according to one embodiment may include an operation (S20) of sampling spectrum data 10 to obtain a first measurement position. The operation (S20) of obtaining a first measurement position by sampling the spectrum data 10 may include an operation (S21) of classifying the spectrum data 10 into k groups. In one embodiment, the value of k, which is the number of groupings, may be adjusted according to the designer's intention, and by adjusting the value of k, the representative power or a representation ability of a characteristic value in a specific zone within the wafer W may be increased.

In one embodiment, the spectrum data 10 may be classified into k groups (k is a natural number greater than or equal to 2) based on or using the k-means clustering algorithm. The k-means clustering algorithm is a method of dividing data into k groups (clusters), and each cluster may be defined based on a centroid according to the characteristics of the data. For example, the k-means clustering algorithm may create k clusters by randomly setting k initial centroids in the data and then assigning each data point to the nearest centroid. A distance between each data point and the center/centroid may be measured using the Euclidean distance. Afterwards, an average of the data included in each cluster is calculated and updated to a new center/centroid, and such allocation and center/centroid update may be repeated, e.g., until the centroids are not changed.

For example, the k-means clustering algorithm may divide the spectrum data 10 in all semiconductor chips C included in the wafer W into k groups and update the center/centroid value of the group in a direction in which the dispersion is the smallest within each of the k groups. Through this, the positions (first measurement positions) of representative semiconductor chips C showing similar spectrum characteristics within the wafer W may be selected.

In one embodiment, the spectrum data 10 may be classified into k groups according to radii of concentric circles within the wafer W. For example, the spectrum data 10 may be classified at each radius of a predetermined interval based on or from the center of the wafer W. This classification may reflect a difference in characteristics of the semiconductor chips C between the center and an edge of the wafer W. The classification method of the spectrum data 10 according to various embodiments is not limited to the classification based on or using the k-means clustering algorithm described above and the classification according to the radii of the concentric circles, and various classification techniques may be used. For example, in one embodiment, the spectrum data 10 may be classified by a distance-based interpolation method or may be randomly classified.

In one embodiment, the wafer inspection method according to one embodiment may further include an operation (S15) of reducing the dimension of the spectrum data 10 before the operation (S20) of sampling the spectrum data to obtain the first measurement position. The operation (S15) of reducing the dimension of the spectrum data 10 may be performed through a principal component analysis (PCA) technique. Because spectrum data 10 is usually composed of multiple wavelengths, the dimension of the spectrum data 10 may be reduced through principal component analysis, thereby improving the computational efficiency of k-means clustering that may be performed later and reducing noise.

Referring to FIGS. 4 and 5, after the spectrum data 10 is classified into k groups (S21), a total of n (n is a natural number equal to or greater than k) spectrum data may be selected from the k groups (S22). In one embodiment, n spectrum data (hereinafter, sample spectrum data) 20 may be randomly selected from the k groups. The sample spectrum data 20 may include at least one data selected from each of the k groups. For example, the sample spectrum data 20 may include data of at least one spectrum from each of the classified k groups.

In the operation of obtaining a first measurement position by sampling the spectrum data 10 (S20), a first measurement position corresponding to each of the n spectrum data (sample spectrum data 20) may be obtained (S23). The first measurement position on the wafer W obtained by sampling the spectrum data 10 may be a position corresponding to the sample spectrum data 20 described above. For example, the first measurement position may be a position on the wafer W where the sample spectrum data 20 is obtained through measurement.

The wafer inspection method according to various embodiments may select the first measurement position that reflects the distribution of the spectrum that may be measured from the wafer W as much as possible through sampling including a classification operation after obtaining the spectrum data 10 for the wafer W. The first measurement position is a measurement position on the wafer W that measures the characteristic value used in the subsequent prediction model generation process, and as described above, the first measurement position represents a position with similar characteristics, and thus, the accuracy of the prediction model may be improved.

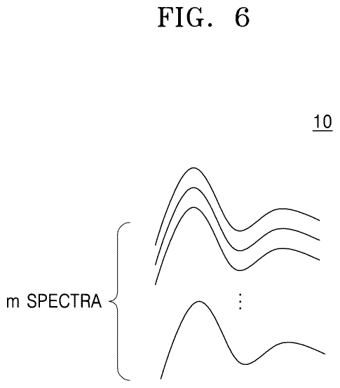

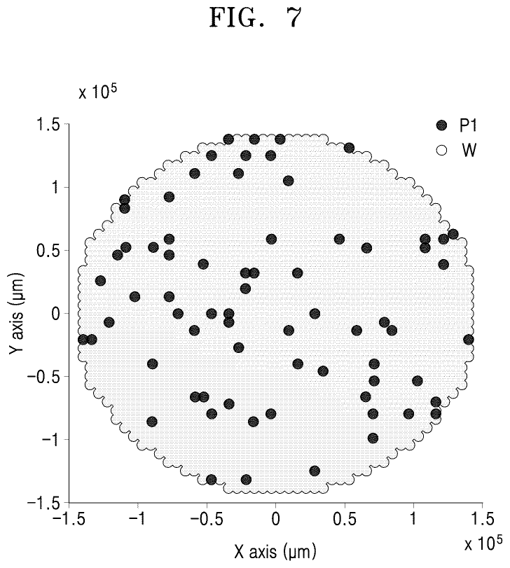

FIG. 6 is a diagram illustrating spectrum data 10 according to one embodiment. FIG. 7 is a diagram for explaining k-means clustering according to one embodiment.

Referring to FIG. 6, the spectrum data 10 for a wafer W (see FIG. 3) may include multiple spectra, and for example, when the wafer W (see FIG. 3) includes m semiconductor chips C (see FIG. 3), the spectrum data 10 may include m spectra. In this case, the spectrum data 10 may include information on all semiconductor chips C (see FIG. 3) included in the wafer W (see FIG. 3).

The wafer inspection method according to one embodiment may cluster the spectrum data through k-means clustering. For example, FIG. 7 shows first measurement positions P1 acquired by selecting n spectrum data after classifying the spectrum data 10 into k groups based on or using the k-means clustering algorithm. Referring to FIG. 7, the first measurement positions P1 may be selected as various positions within the wafer W.

Referring again to FIG. 1 and FIG. 5, the wafer inspection method according to one embodiment may include an operation (S30) of measuring characteristic values of the wafer W (see FIG. 3) at the first measurement positions P1 (see FIG. 7). In one embodiment, a characteristic value 30 measured at the first measurement position P1 may be a critical dimension CD of a pattern of the wafer W (see FIG. 3) or a concentration on a surface of the wafer W (see FIG. 3). The concentration on the surface of the wafer may be, for example, a concentration of one of various substances existing on the surface of the wafer, such as fluorine or hydrogen. For example, the concentration of a substance on the surface of the wafer may be a concentration of the substance on the surface and/or in the vicinity of the surface of the wafer. For example, the vicinity of the surface of the wafer may range from the surface of the wafer to several nanometers under the surface of the wafer. In certain embodiments, the vicinity of the surface of the wafer may range from the surface of the wafer to several micrometers, to tens of micrometers, or to hundreds of micrometers below the surface of the wafer.

In one embodiment, the operation (S30) of measuring the characteristic value of the wafer W at the first measurement position P1 may be performed using at least one of a high-acceleration critical dimension scanning electron microscope (CD-SEM), an x-ray diffraction (XRD), an x-ray photoelectron spectroscopy (XPS), and an x-ray fluorescence spectroscopy (XRF). In one embodiment, a CD at the first measurement position P1 may be measured using the high-acceleration CD-SEM, or the concentration on the surface of the wafer W at the first measurement position P1 may be measured using an X-ray facility/machine.

The field-of-view (FOV) of a high-acceleration CD-SEM is small, for example, at a level of several hundred nanometers, and thus, it takes a long time for measurement of characteristics of the wafer W, e.g., a critical dimension. Similarly, in the case of an x-ray facility/machine, a sufficient cooling time is required for temperature control of the x-ray source, and thus, it takes a long time for measurement of characteristics of the wafer W, e.g., a concentration of a substance. Because the wafer inspection method according to various embodiments of the present disclosure requires actual measurement only at the first measurement positions P1 obtained by classifying and/or sampling the spectrum data 10, the time for characterizing a front surface of the wafer W may be effectively shortened.

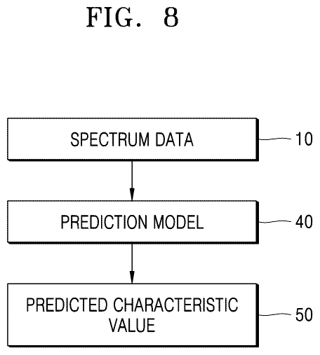

Referring to FIGS. 1 and 5, the wafer inspection method according to one embodiment may include an operation (S40) of generating a prediction model 40. The prediction model 40 may be generated based on or using the spectrum data (i.e., sample spectrum data 20) at the first measurement positions P1 and the characteristic values 30 measured at the first measurement positions P1. The prediction model 40 may be a regression analysis model that receives the spectrum data 10 and outputs a corresponding predicted characteristic value 50 (see FIG. 8). In one embodiment, the prediction model 40 may be a regression model based on or using at least one of a learning model, a weighted sum method model, and a multi-input single-output (MISO) model. In one embodiment, a prediction model 40 may be generated for each wafer. For example. Different prediction models may be generated for different wafers. For example, a prediction model for a wafer may be different from another prediction model for another wafer.

As described above, because the first measurement positions P1 may be obtained as the positions of representative semiconductor chips C showing similar spectrum characteristics within the wafer W (because the first measurement positions P1 may be the measurement optimum points), the prediction model 40 generated based on or using the characteristic values 30 measured at the first measurement positions P1 may relatively accurately predict the characteristic value of a position that has not actually been measured.

FIG. 8 is a diagram for explaining a wafer inspection method according to one embodiment.

Referring to FIGS. 1 and 8, the wafer inspection method according to one embodiment may include an operation (S50) of extracting the predicted characteristic value 50 based on or using the prediction model 40. The spectrum data 10 for a wafer W may be input into the prediction model 40 to output a predicted characteristic value 50 of the wafer (W). The wafer inspection method according to one embodiment may include an operation of extracting the predicted characteristic value 50 of the wafer W at a second measurement position different from a first measurement position P1 on the wafer W based on or using the prediction model 40. Through extracting the predicted characteristic value 50 based on or using the prediction model 40, the front surface of the wafer W may be characterized.

The wafer inspection method according to various embodiments may obtain the spectrum data 10 with a relatively fast measurement (e.g., in a relatively short measurement time), sample the spectrum data 10 to select an optimal measurement position (first measurement position P1), and then, perform actual measurement of the characteristic value only at that position. Thereafter, the predicted characteristic value 50 at a position that was not actually measured may be extracted using the prediction model 40 generated based on or using the actually measured characteristic value 30 and the sample spectrum data 20. For example, the wafer inspection method according to various embodiments may achieve characterization of the semiconductor chip on the front side of the wafer while efficiently reducing reference measurements (CD-SEM, x-ray measurement, etc.) that are important for characterization, although it takes a long time for measurement. In addition, by characterizing the semiconductor chip on the front side of the wafer, it is possible to easily find a vulnerable position of the wafer.

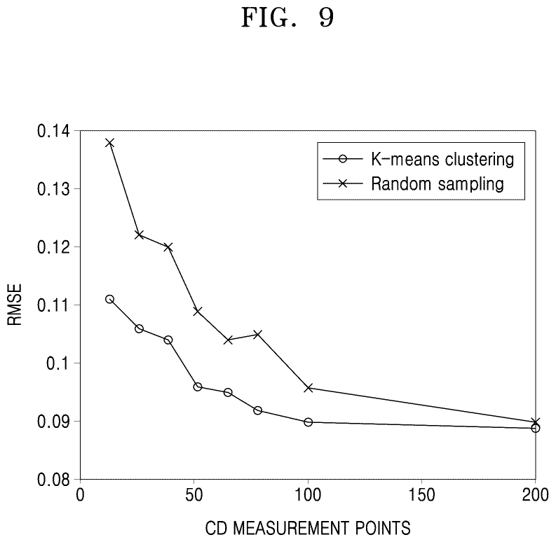

FIG. 9 is a graph showing evaluation data of the wafer inspection method according to one embodiment.

FIG. 9 shows evaluation data of Embodiment 1, in which spectrum data 10 is classified and sampled based on or using the k-means clustering algorithm and Embodiment 2, in which spectrum data 10 is randomly sampled in obtaining the first measurement position P1. The evaluation data shows a predicted CD value of the prediction model generated using the first measurement position acquired by each of Embodiment 1 and Embodiment 2, and the root mean square error (RMSE) of the actual CD value. Referring to FIG. 9, the prediction model of Embodiment 1, in which the spectrum data 10 are sampled by classifying the spectrum data 10 based on or using the k-means clustering algorithm, has a lower RMSE value than the prediction model of Embodiment 2, which the spectrum data 10 are randomly sampled.

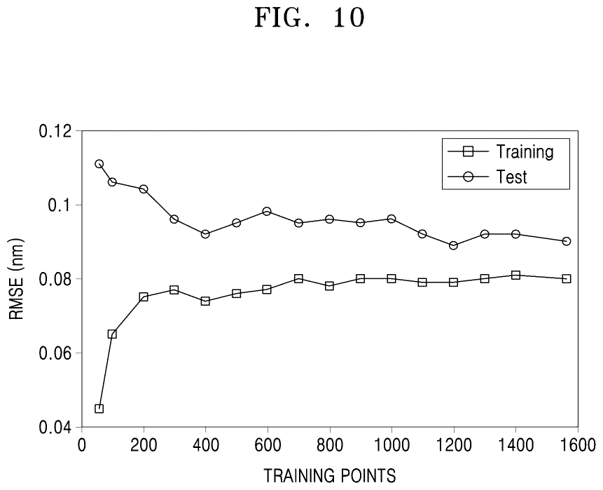

FIG. 10 is a graph showing evaluation data of a wafer inspection method according to one embodiment. FIG. 10 shows an embodiment in which the prediction model is a regression model based on or using a machine learning model.

Referring to FIG. 10, as the number of measurement positions (Training points) used for training increases, the RMSE of the training data (Training) increases, but the RMSE of the test data (Test) decreases. When the machine learning model is trained with the spectrum (200 sample spectrum data) and CD measurement values at 200 measurement positions, the RMSE between the actual CD value and the predicted CD value at the remaining measurement positions falls below 0.1 nm.

In one embodiment, the prediction model may be a regression model based on or using the MISO model. Referring to Table 1, when the prediction model is generated based on or using the MISO model, the normal/bad perspective map match (F1-score) of the CD actual map and the CD predicted map is higher than the map match (F1-score) when the prediction model is generated based on or using the machine learning model ML or the weighted linear combination model WS. Here, the map match (F1-score) is a score for the match that predicts normal as normal and bad as bad after distinguishing normal/bad according to the CD value, and a higher value means that both normal and bad are well matched.

TABLE 1
F1-score (Map match)

| | 25 pt | 70 pt | 100 pt |
|---|---|---|---|
| ML | 54.8 | 58.9 | 70.7 |
| WS | 50.7 | 64.8 | 66.9 |
| MISO | 61.1 | 66.3 | 72.0 |

*ML: Machine learning
**WS: Weight sum
***MISO: Multi-input single output

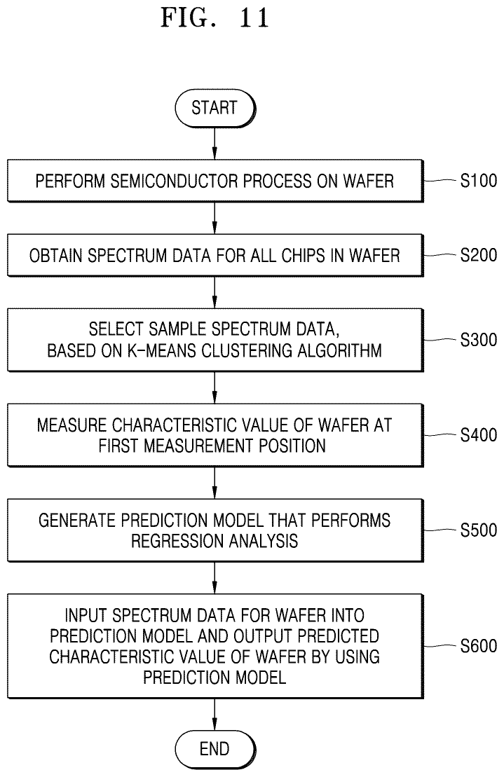

FIG. 11 is a flowchart for explaining a method of manufacturing a semiconductor device according to an embodiment.

Referring to FIG. 11, the method of manufacturing a semiconductor device according to an embodiment first performs a semiconductor process on a wafer (S100). For example, the semiconductor process may include i) an oxidation process for forming an oxide film, ii) a lithography process including spin coating, exposure, and development, iii) a thin film deposition process, iv) a dry or wet etching process, and v) a metal wiring process. For example, the semiconductor process may include processes forming various conductive patterns and insulating layers to form various semiconductor devices and wirings on the wafer. For example, semiconductor processes in the present disclosure may be processes manufacturing semiconductor devices.

Thereafter, the method may include an operation of obtaining spectrum data for all chips in the wafer (S200), an operation of selecting sample spectrum data by sampling the spectrum data based on or using a k-means clustering algorithm (S300), an operation of measuring a characteristic value of the wafer at a first measurement position on the wafer corresponding to the sample spectrum data (S400), an operation of generating a prediction model that performs regression analysis based on or using the sample spectrum data and the characteristic value of the wafer (S500), and an operation of outputting a predicted characteristic value of the wafer by inputting spectrum data for the wafer into the prediction model (S600). For example, the first measurement position on the wafer may be the position at which the sample spectrum data has been obtained. For example, characteristic values of the wafer may be measured at a plurality of first measurement positions on the wafer at which sample spectrum data used to generate the prediction model have been obtained, respectively.

The operation (S200) of acquiring spectrum data for all chips in the wafer may correspond to the operation (S10) of acquiring spectrum data (10) for the wafer W described above through FIGS. 1 to 9 (may be substantially the same). The operation (S300) of sampling spectrum data based on or using a k-means clustering algorithm to select sample spectrum data may correspond to the operation (S20) of sampling spectrum data 10 to acquire a first measurement position P1 described above through FIGS. 1 to 8. The operation (S400) of measuring characteristic values of the wafer at the first measurement position on the wafer corresponding to the sample spectrum data may correspond to the operation (S30) of the measuring characteristic value 30 of the wafer at the first measurement position P1 described above with reference to FIGS. 1 to 8. The operation (S500) of generating a prediction model that performs regression analysis based on or using the sample spectrum data and the characteristic value of the wafer may correspond to the operation (S40) of generating a prediction model (40) described above with reference to FIGS. 1 to 8. The operation (S600) of outputting the predicted characteristic values of the wafer by inputting spectrum data for the wafer into the prediction model may correspond to the operation (S50) of extracting the predicted characteristic values 50 based on or using the prediction model 40 described above with reference to FIGS. 1 to 8. For example, the method of manufacturing a semiconductor device of the present embodiment may use the inspection methods of the previous embodiments to expedite inspection processes during the manufacturing process of the semiconductor device.

Afterwards, a subsequent semiconductor process may be performed on the wafer. The subsequent semiconductor process on the wafer may include various processes. For example, the subsequent semiconductor process may include a deposition process, an etching process, an ion process, a cleaning process, etc. In addition, the subsequent semiconductor process may include a singulation process that individualizes the wafer into a plurality of semiconductor chips, a test process that tests the semiconductor chips, and a packaging process that packages the semiconductor chips. A semiconductor device may be completed through the subsequent semiconductor processes on the wafer and following packaging processes of the individualized semiconductor chips.

For example, the semiconductor device may include at least one of volatile memory or nonvolatile memory. The nonvolatile memory includes read only memory (ROM), programmable ROM (PROM), electrically programmable ROM (EPROM), electrically erasable and programmable ROM (EEPROM), flash memory, phase-change RAM (PRAM), magnetic RAM (MRAM), resistive RAM (RRAM), ferroelectric RAM (FRAM), etc. The volatile memory includes dynamic RAM (DRAM), static RAM (SRAM), synchronous DRAM (SDRAM), PRAM (Phase-change RAM), MRAM, RRAM, ferroelectric RAM (FeRAM), etc. In an embodiment, the semiconductor device may include at least one of hard disk drive (HDD), solid state drive (SSD), compact flash (CF), secure digital (SD), micro secure digital (Micro-SD), mini secure digital (Mini-SD), or Memory Stick.

A method of manufacturing a semiconductor device according to one embodiment obtains the spectrum data 10 with a relatively fast measurement (e.g., in a relatively short measurement time) for a wafer on which a predetermined semiconductor process has been performed, samples the spectrum data 10 to select an optimal measurement position (first measurement position P1), and then performs actual measurement of characteristic values only at that position. Afterwards, predicted characteristic values 50 at positions that were not actually measured may be extracted using the prediction model 40 generated based on or using the actually measured characteristic value 30 and the sample spectrum data 20. For example, the method of manufacturing a semiconductor device according to various embodiments may achieve characterizations of semiconductor chips on the entire surface of a wafer, including positions where the characteristic values are not measured. Through this, the time required for the semiconductor device manufacturing process may be shortened, and a semiconductor device with improved reliability may be manufactured by discovering vulnerable points of the wafer.

At least some of the operations included in the wafer inspection method according to one embodiment and the semiconductor device manufacturing method including the same may be performed by using an electronic device including a memory and one or more processors.

The memory may store computer-readable instructions. When the instructions stored in the memory are executed by a processor, the processor may process operations defined by the instructions. The memory may include, for example, RAM, DRAM, SRAM, or other forms of nonvolatile memory known in the art.

One or more processors according to one embodiment may control an overall operation of the electronic device. The processor may be a hardware-implemented device having circuitry having a physical structure for executing desired operations. The desired operations may include code or instructions included in a program. The hardware-implemented device may include a microprocessor, a central processing unit (CPU), a graphic processing unit (GPU), a processor core, a multi-core processor, a multiprocessor, an application-specific integrated circuit (ASIC), a field programmable gate array (FPGA), a neural processing unit (NPU), and the like.

While the inventive concept has been particularly shown and described with reference to embodiments thereof, it will be understood that various changes in form and details may be made therein without departing from the spirit and scope of the following claims.

What is claimed is:

1. A wafer inspection method comprising:
obtaining spectrum data for a wafer;
obtaining a first measurement position on the wafer by sampling the spectrum data;
measuring a characteristic value of the wafer at the first measurement position; and
generating a prediction model, using the spectrum data and the characteristic value at the first measurement position.

2. The wafer inspection method of claim 1, further comprising:
using the prediction model, extracting predicted characteristic values of the wafer at a second measurement position on the wafer, the second measurement position being different from the first measurement position.

3. The wafer inspection method of claim 1, wherein
the sampling of the spectrum data includes classifying the spectrum data into k groups (k is a natural number greater than or equal to 2), based on a k-means clustering algorithm.

4. The wafer inspection method of claim 3, further comprising:
reducing dimensionality of the spectrum data by using a principal component analysis (PCA) technique, before the sampling of the spectrum data.

5. The wafer inspection method of claim 3, wherein
the sampling of the spectrum data includes selecting a total of n (where n is a natural number greater than or equal to k) spectrum data from the k groups.

6. The wafer inspection method of claim 5, wherein
the first measurement position corresponds to one of the n spectrum data.

7. The wafer inspection method of claim 5, wherein the n spectrum data comprise at least one data selected from each of the k groups.

8. The wafer inspection method of claim 1, wherein
the sampling of the spectrum data includes classifying the spectrum data according to radii of concentric circles within the wafer.

9. The wafer inspection method of claim 1, wherein
the spectrum data for the wafer includes spectrum data measured for all semiconductor chips included in the wafer.

10. The wafer inspection method of claim 1, wherein
the characteristic value of the wafer is a critical dimension CD of a pattern of the wafer or a concentration of a substance on a surface of the wafer.

11. The wafer inspection method of claim 10, wherein
the concentration of the substance on the surface of the wafer is at least one of a fluorine concentration and a hydrogen concentration on the surface of the wafer.

12. The wafer inspection method of claim 1, wherein
the prediction model is a regression model based on at least one of a machine learning model, a weighted sum method model, and a multi-input single-output (MISO) model.

13. A wafer inspection method comprising:
obtaining spectrum data for a wafer;
classifying the spectrum data into k groups (k is a natural number greater than or equal to 2);
selecting a total of n (n is a natural number greater than or equal to k) spectrum data from the k groups;
measuring characteristic values of the wafer at first measurement positions corresponding to the n spectrum data, respectively;
generating a prediction model using the n spectrum data and the characteristic values; and
outputting a predicted characteristic value of the wafer by inputting spectrum data for the wafer into the prediction model.

14. The wafer inspection method of claim 13, wherein the n spectrum data comprise at least one data selected from each of the k groups.

15. The wafer inspection method of claim 13, further comprising:
reducing dimensionality of the spectrum data by using a principal component analysis technique, before classifying the spectrum data into k groups.

16. The wafer inspection method of claim 13, wherein
the characteristic values and the predicted characteristic value are critical dimensions of patterns of the wafer or concentrations of a substance on a surface of the wafer.

17. The wafer inspection method of claim 13, further comprising:
generating another prediction model for another wafer,
wherein the two prediction models are different from each other.

18. The wafer inspection method of claim 13, wherein
the classifying of the spectrum data into k groups includes classifying the spectrum data according to radii of concentric circles within the wafer or classifying the spectrum data using a k-means clustering algorithm.

19. The wafer inspection method of claim 13, wherein
the measuring of the characteristic values of the wafer at the first measurement positions includes measuring the characteristic values of the wafer by using at least one of a high-acceleration critical dimension scanning electron microscope (CD-SEM), x-ray diffraction (XRD), x-ray photoelectron spectroscopy (XPS), and x-ray fluorescence spectroscopy (XRF).

20. A method of manufacturing a semiconductor device, the method comprising:
performing a semiconductor process on a wafer;
obtaining spectrum data for all chips included in the wafer;
selecting sample spectrum data by sampling the spectrum data, based on a k-means clustering algorithm;
measuring characteristic values of the wafer at first measurement positions on the wafer corresponding to the sample spectrum data;
generating a prediction model for performing regression analysis, based on the sample spectrum data and the characteristic values; and
outputting a predicted characteristic value of the wafer by inputting spectrum data for the wafer into the prediction model.
